(19) United States
(12) Patent Application Publication
(10) Pub. No.: US 2006/0174704 A1
(43) Pub. Date: Aug. 10, 2006

(54) Acceleration sensor

(75) Inventor: Koichi Tsubaki, Chiryu-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/332,330

(22) Filed: Jan. 17, 2006

(30) Foreign Application Priority Data
Feb. 8, 2005 (JP) 2005-032072

(51) Int. Cl. G01P 15/00

(52) U.S. Cl. 73/514.16

(57) ABSTRACT

An acceleration sensor includes a sensor chip having a substrate, a movable electrode supported with respect to the substrate to have a displacement in a direction of acceleration, and a fixed electrode facing the movable electrode with a detection gap. The sensor chip is mounted on a package through an adhesive member. The adhesive member is disposed in such a manner that the disposed area is larger in a direction perpendicular to the acceleration direction than in the acceleration direction. Such a layout of the adhesive member prevents the substrate of the sensor chip from being warped in the acceleration direction by thermal stress. Therefore, the detection gap hardly varies with temperature.

### CROSS REFERENCE TO RELATED APPLICATION

This application is based on and incorporates herein by reference Japanese Patent Application No. 2005-32072 filed on Feb. 8, 2005.

### FIELD OF THE INVENTION

The present invention relates to an acceleration sensor.

### BACKGROUND OF THE INVENTION

An acceleration sensor generally includes a sensor chip having a movable electrode and a fixed electrode that are disposed with respect to a semiconductor substrate to face each other with a gap (detection gap) in a detection axis direction of acceleration.

When acceleration is applied to the sensor, the movable electrode is displaced toward the detection axis direction so that the gap distance between the movable electrode and the fixed electrode changes. As a result of the change in the gap distance, capacitance between the electrodes also changes. The sensor detects the applied acceleration based on the change in the capacitance.

The sensor chip is mounted and supported on a package through an adhesive member. The package is made of ceramic, for example.

An acceleration sensor having such a sensor chip is disclosed in, for example, U.S. Pat. No. 6,923,060 corresponding to JP-A-2004-69349. In the sensor, the sensor chip and a circuit chip for processing an output of the sensor chip are joined together as one assembly (ASSY). The ASSY is bonded on a package made of, for example, ceramic through a resin adhesive member.

Such conventional acceleration sensors have the following problem. The sensor output value changes in response to a change in sensor operating temperature. In other words, the sensor output value has temperature characteristics, i.e., dependence.

The problem may result from deformation of the sensor chip. The deformation may be caused by thermal stresses applied from the sensor chip itself or surrounding parts such as a package

As described above, when acceleration is applied to the sensor in the detection axis direction, the detection gap between the movable electrode and the fixed electrode of the sensor chip changes. The sensor detects the applied acceleration based on the gap change.

In the sensor, if the sensor chip is deformed by the thermal stresses, a substrate as a base of the sensor chip may be also deformed or warped. As a result, the detection gap between the fixed electrode and the movable electrode changes, because the electrodes are disposed on the substrate. Therefore, an error is introduced into the sensor output value so as to increase temperature characteristics of the sensor output value.

### SUMMARY OF THE INVENTION

In view of the above-described problem, it is an object of the present invention to provide an acceleration sensor for preventing a sensor output value from varying with a sensor operating temperature.

A pressure sensor includes a sensor chip having a substrate, a movable electrode supported with respect to the substrate to be displaced toward a detection axis direction and fixed electrodes disposed to face the movable electrode, a package for supporting the sensor chip, and an adhesive member interposed between the sensor chip and the package for fixing the sensor chip to the package.

When acceleration is applied to the sensor, the movable electrode is displaced in the detection axis direction. As a result of the displacement, a detection gap between the movable electrode and the fixed electrodes changes. The sensor detects the applied acceleration based on the detection gap change.

The adhesive member is disposed in such a manner that warpage of the substrate of the sensor chip is more reduced in the detection axis direction than in a direction perpendicular to the detection axis direction. Thus, the sensor prevents the sensor output value from varying with the sensor operating temperature.

Alternatively, the adhesive member may has a plurality of adhesive pieces that are disposed in a line in the direction perpendicular to the detection axis direction.

### BRIEF DESCRIPTION OF THE DRAWINGS

The above and other objectives, features and advantages of the present invention will become more apparent from the following detailed description made with reference to the accompanying drawings. In the drawings:

FIG. 1A is a plan view showing an acceleration sensor according to an embodiment of the present invention, and FIG. 1B is a cross-sectional view along a direction Y of FIG. 1 B;

FIG. 2 is a plan view showing a sensor chip of the sensor in FIG. 1A;

FIG. 3 is a cross-sectional view taken along line III-III of FIG. 2;

FIG. 4 is a cross-sectional view taken along line IV-IV of FIG. 2;

FIG. 5 is a plan view showing a layout of an adhesive member of the sensor in FIG. 1A;

FIG. 6 is a circuit diagram of an acceleration detection circuit of the sensor in FIG. 1A;

FIG. 7 is a graph showing a result of an investigation of temperature characteristics of the sensor in FIG. 1A;

FIG. 8 is a plan view showing a layout of an adhesive member in an acceleration sensor according to a prior art, and

FIG. 9 is a graph showing a result of an investigation of temperature characteristics of the sensor shown in FIG. 8.

### DETAILED DESCRIPTION OF THE PREFERRED EMBODIMENT

The present inventor has preliminarily investigated the deformation of the sensor chip and found a relation between the deformation and a layout of the adhesive members for bonding the sensor chip to the package.

FIG. 8 illustrates a layout of adhesive members in the acceleration sensor, which is disclosed in U.S. Pat. No. 6,923,060, as a comparison of the preferred embodiment. In the sensor, the adhesive members bond a circuit chip to the package. Therefore, FIG. 8 shows a bonding surface of the circuit chip, not the sensor chip.

However, the sensor chip and the circuit chip are jointed together so that bonded condition between the sensor chip and the package depends on the layout of the adhesive members that bond the circuit chip to the package.

The present inventor has preliminarily investigated temperature characteristics of sensors having the same layout of the adhesive members as shown in FIG. 8.

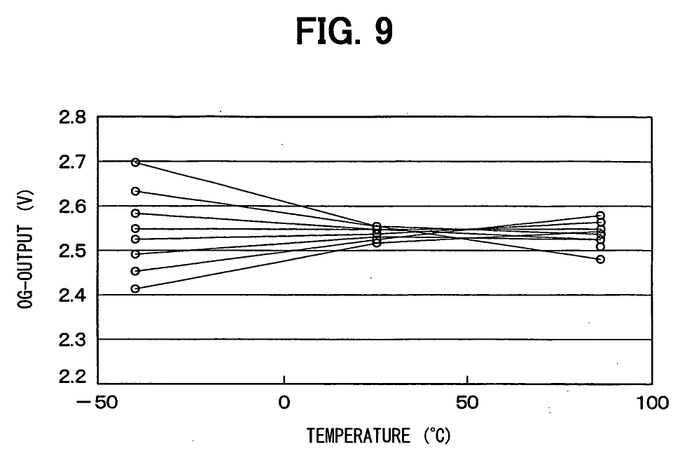

FIG. 9 shows a result of the temperature characteristics investigation. As understood from FIG. 9, in the conventional sensor, the sensor output value greatly varies with sensor operating temperature.

The present inventor has observed the sensor chip used in the temperature characteristics investigation. As a result, it is discovered that the sensor chip is greatly warped in the detection axis direction, as the sensor chip has larger output variation with the temperature.

In the sensor chip, the movable electrode and the fixed electrodes face each other with the detection gap in the detection axis direction.

Therefore, when the substrate of the sensor chip is greatly warped in the detection axis direction by thermal stress, the detection gap between the movable electrode and the fixed electrodes changes. In other words, the detection gap changes with the temperature. Thus, the sensor output value also changes with the temperature.

The investigation discloses that the adhesive member layout shown in FIG. 8 causes the substrate of the sensor chip to be greatly warped in the detection axis direction.

Therefore, reducing the detection axis direction warpage of the substrate may reduce the temperature characteristics of the sensor output value.

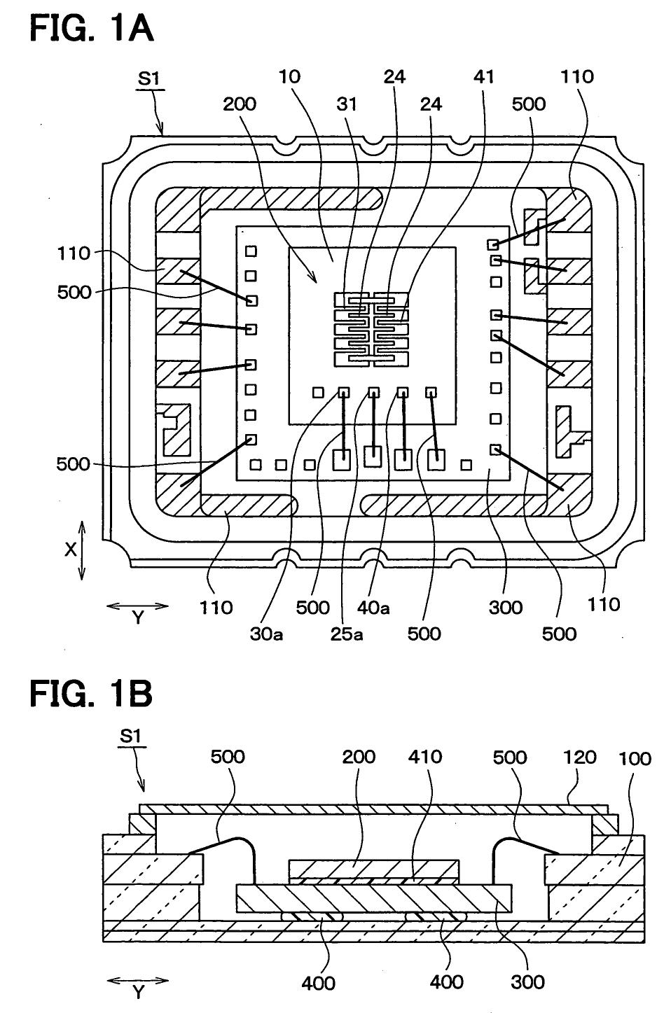

Reference is made to FIGS. 1A and 1B, which show an acceleration sensor S1 according to an embodiment of the present invention. The acceleration sensor S1 is a differential capacitance type acceleration sensor. Example applications for the sensor S1 include a gyroscopic sensor and an acceleration sensor for controlling an airbag system, an anti-lock brake system (ABS), and a vehicle stability control (VSC) system.

The sensor S1 includes a package 100, a sensor chip 200, a circuit chip 300, and adhesive members 400. The sensor chip 200 and the circuit chip 300 are supported on the package 100. The adhesive members 400 bond the sensor chip 200 to the package 100 through the circuit chip 300.

The package 100 is for accommodating the sensor chip 200 and the circuit chip 300. The package 100 provides a base of the sensor S1 and works as an attachment for mounting the sensor S1 to an object to be measured.

The package 100 may be, for example, made of ceramic and constructed as a multilayer substrate of ceramic films such as an alumina (Al₂O₃) film. In the package 100, through holes are disposed so as to penetrate each layer of the ceramic films, and wiring is disposed in the through holes.

As shown in FIG. 1A, wiring members 110 are disposed on a surface of the package 100. The sensor S1 can be electrically connected to an external circuit through the wiring members 110.

As shown in FIG. 1B, a lid 120 is attached to an opening portion of the package 100 by, for example, welding and brazing so as to seal the inside of the package 100. The lid 120 is made of metal, resin, or ceramic, for example.

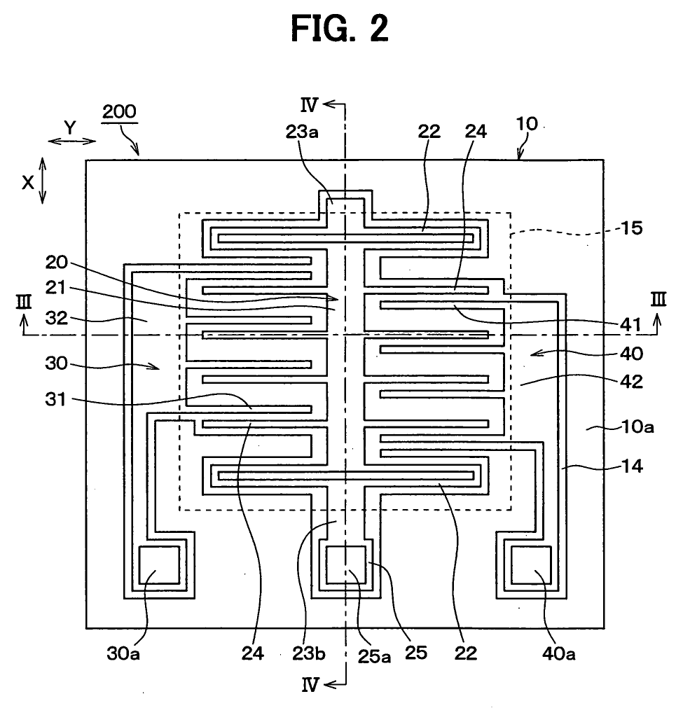

The sensor chip 200 is described in detail below with reference to FIGS. 2 to 4. Applying a micromachining process to a semiconductor substrate 10 produces the sensor chip 200.

The substrate 10 of the sensor chip 200 is a silicon-on-insulator (SOI) substrate having a rectangle shape. As shown in FIG. 4, the substrate 10 has a first silicon substrate 11 as a base substrate, a second silicon substrate 12, and an insulation oxide film 13 interposed between the substrates 11, 12.

There is a beam structure having a comb shape on the second silicon substrate 12. Forming trenches 14 on the second silicon substrate 12 forms the beam structure that includes movable portions 20 and fixed portions 30, 40.

In the substrate 10, the first silicon substrate 11 and the oxide film 13 are partly removed for forming an opening portion 15. As shown in FIG. 2, the opening portion 15 corresponds to the area where the beam structure of the second silicon substrate 12 is formed.

The sensor chip 200 may be, for example, manufactured as follows.

A mask having a shape of the beam structure is formed on the second silicon substrate 12 of the substrate 10 by photolithography technique.

Then, dry etching process using, for example, sulfur hexafluoride (SF₆) gas or carbon-fluorine gas (CF₄) is applied to the second silicon substrate 12 in order to form the trenches 14, so that the beam structure is formed at once.

Then, wet etching process using, for example, potassium hydroxide (KOH) etchant is applied to the first silicon substrate 11. Further, the oxide film 13 is removed by dry etching process so that the opening portion 15 is formed. The sensor chip 200 is manufactured in this way.

The movable portion 20 of the sensor chip 200 has a rectangular weight portion 21, spring portions 22, and anchor portions 23a, 23b. Both ends of the weight portion 21 are integrally joined to the anchor portions 23a, 23b through the spring portions 22, respectively.

As shown in FIG. 4, the anchor portions 23a, 23b are fixed to the oxide film 13 and supported on the first silicon substrate 11 as the base substrate through the oxide film 13. Thus, the weight portion 21 and the spring portions 22 of the movable portion 20 are suspended above the opening portion 15.

As shown in FIG. 2, each spring portion 22 has a shape of a rectangular flame such that two parallel beams are joined together at the respective ends. The spring portions 22 works as a spring. Therefore, the spring portions 22 are capable of being displaced in a direction perpendicular to a direction in which the beams extend.

Specifically, the spring portions 22 allow the weight portion 21 to be displaced in a direction parallel to the substrate 10 and in a detection axis direction X shown in FIG. 2, when the sensor S1 experiences acceleration having a component along the direction X. Further, the spring portions 22 allow the displaced weight portion 21 to return to an initial position in accordance with decrease in the acceleration.

Therefore, the movable portion 20 joined to the substrate 10 through the spring portions 22 is capable of being displaced in the direction parallel to the substrate 10 and in the direction X in accordance with the acceleration applied to the sensor S1.

The weight portion 21 of the movable portion 20 has multiple movable electrodes 24. The movable electrodes 24 extend away from both sides of the weight portion 21 in a direction Y perpendicular to the direction X. The direction X is parallel to a direction of the length of the weight portion 21. In short, the movable electrodes 24 are arranged along the direction X to form a comb shape.

As shown in FIG. 2, in this embodiment, the weight portion 21 has four movable electrodes 24 on each side. In other words, the weight portion 21 has eight movable electrodes 24 in total. Each electrode 24 has a shape of a beam being rectangular in cross section and projects from the weight portion 21 over the opening portion 15.

The movable electrodes 24 are capable of being displaced in the direction parallel to the substrate 10 and in the direction X, because the movable electrodes 24 are integrally constructed with the weight portion 21 and the spring portions 22.

As shown in FIG. 2, the anchor portions 23a, 23b of the movable portion 20 are fixed to the oxide film 13 around a pair of opposed sides of the opening portion 15. In contrast, the fixed portions 30, 40 are fixed to the oxide film 13 around another pair of opposed sides of the opening portion 15. The fixed portions 30, 40 are supported on the first silicon substrate 11 as the base substrate through the oxide film 13.

The fixed portions 30, 40 are located in the left side and the right of the weight portion 21, respectively. The fixed portion 30 has left fixed electrodes 31 and left fixed electrode wiring portion 32. The fixed portion 40 has right fixed electrodes 41 and right fixed electrode wiring portion 42.

The fixed electrodes 31, 41 are arranged to form a comb shape so as to be interleaved with the movable electrodes 24 of the movable portion 20.

Specifically, as shown in FIG. 2, the left fixed electrodes 31 are arranged to be located on top of the movable electrodes 24 along the direction X. In contrast, the right fixed electrodes 41 are arranged to be located on bottom of the movable electrodes 24 along the direction X.

The fixed electrodes 31, 41 face the movable electrodes 24 along the direction X. Thus, detection gaps for detection of acceleration are provided between side surfaces of the fixed electrodes 31, 41 and side surfaces of the movable electrodes 24.

The fixed electrodes 31 are electrically insulated from the fixed electrodes 41. The fixed electrodes 31, 41 extend approximately parallel to the movable electrodes 24 and have a shape of a beam being rectangular in cross section.

The fixed electrode wiring portions 32, 42 are fixed to the first silicon substrate 11 as the base substrate through the oxide film 13.

The fixed electrodes 31, 41 stick out from the fixed electrode wiring portions 32, 42 over the opening portion 15, respectively. In other words, the fixed electrodes 31, 41 are cantilevered-type electrodes supported by the fixed electrode wiring portions 32, 42, respectively.

The left fixed electrode wiring portion 32 combines each of the left fixed electrodes 31 so that each of the left fixed electrodes 31 is electrically connected with each other. Likewise, the right fixed electrode wiring portion 42 combines each of the right fixed electrodes 41 so that each of the right fixed electrodes 41 are electrically connected with each other.

The fixed electrode wiring portions 32, 42 have electrode pads 30a, 40a, respectively.

A movable electrode wiring portion 25 having an electrode pad 25a is integrated with the anchor portion 23b of the movable portion 20. The electrodes pads 25a, 30a, 40a are disposed by means of, for example, sputtering or deposition of aluminum.

In addition to the pads 25a, 30a, 40a, the substrate 10 has various pads such as a reference potential pad for holding the substrate 10 at a fixed potential.

The circuit chip 300 is bonded to the sensor chip 200 through the adhesive film 410 to face the first silicon substrate 11 of the sensor chip 200. The circuit chip 300 detects or checks a signal outputted from the sensor chip 200.

The circuit chip 300 may be manufactured by forming a metal oxide semiconductor field effect transistor on a semiconductor substrate such as a silicon substrate.

The adhesive film 410 may be a resin film that allows thermocompression bonding. For example, a polyimide resin tape may be used as the adhesive film 410.

Bonding wires 500 electrically connects between the circuit chip 300 and the pads 25a, 30a, 40a, which are disposed on the second silicon substrate 12 of the sensor chip 200. The bonding wires 500 are made of, for example, gold or aluminum and disposed by wire bonding method.

The circuit chip 300 integrally joined to the sensor chip 200 is bonded to the package 100 through the resin adhesive members 400.

In the sensor S1, the sensor chip 200 is supported on the package 100 through the circuit chip 300 that are bonded to the package 100 by the adhesive member 400. In other words, the sensor chip 200 is bonded to the package 100 by the adhesive member 400 interposed between the package 100 and the circuit chip 300.

The adhesive member 400 may be made of, for example, bonding material such as silicone resin, epoxy resin, acrylic resin, or polyimide resin. The bonding material is hardened so as to bond between objects after being applied thereto. The adhesive film 41 may be used as the adhesive member 400. In this embodiment, the adhesive member 400 is made of silicone resin.

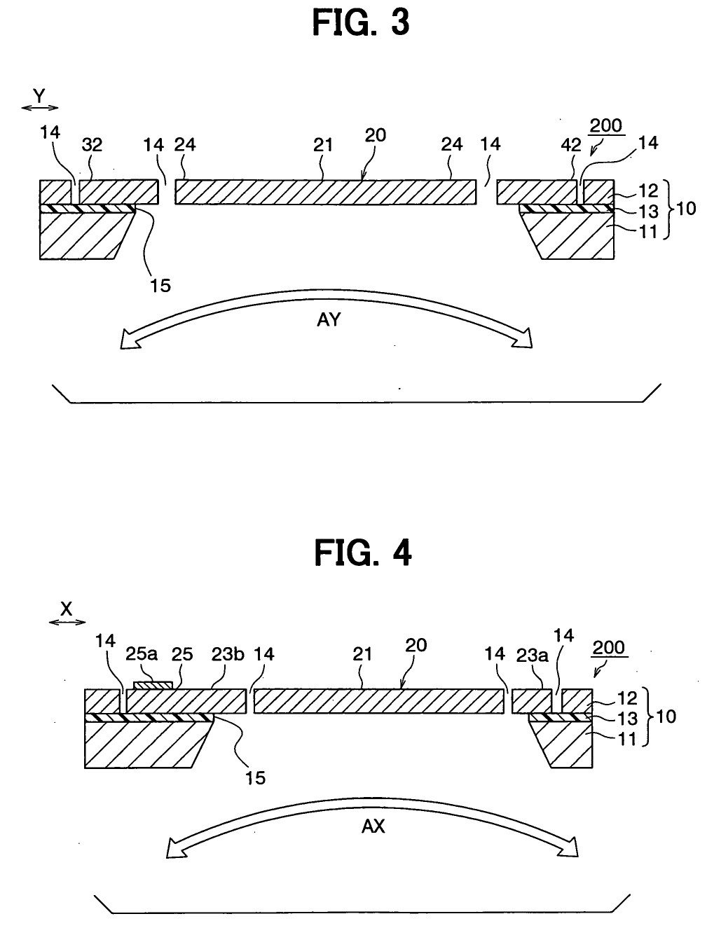

The adhesive member 400 is disposed in such a manner that the substrate 10 has a first warpage WX smaller than a second warpage WY when thermal stress is applied thereto. Here, the first warpage WX is warpage occurred in the direction X and represented by an arrow AX shown in FIG. 4. The second warpage WY is warpage occurred in the direction Y and represented by an arrow AY shown in FIG. 3.

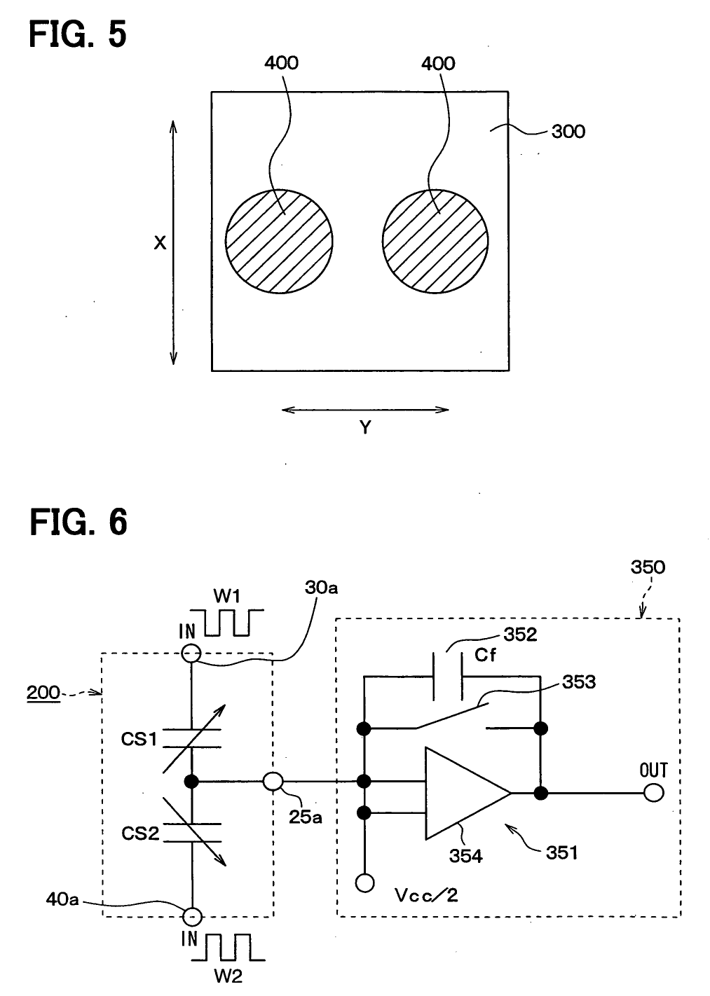

FIG. 5 shows a layout of the adhesive members 400 disposed on one surface of the circuit chip 300. The circuit chip 300 and the package 100 are bonded together on the surface.

As understood from FIG. 5, the adhesive members 400 are disposed in a line in the direction Y so that the disposed area of the adhesive members 400 is larger in the direction Y than in the direction X. A length of the disposed area in the Y direction is longer than that in the X direction.

In contrast, as shown in FIG. 8, in the conventional sensor, the adhesive members 400 are equally disposed in the directions X, Y so that the disposed area of the adhesive members 400 is almost the same in the directions X, Y. A length of the disposed area in the Y direction is almost the same as that in the X direction.

As shown in FIG. 1, the circuit chip 300 is electrically connected to the wiring members 110 of the package 100 through the bonding wires 500. Thus, the package 100, the sensor chip 200, and the circuit chip 300 are electrically connected with each other through the bonding wires 500.

Therefore, the sensor chip 200 can provide and receive an electric signal to and from the circuit chip 300. The circuit chip 300 processes the received signal and outputs the processed signal to an external circuit through the wiring portions 110 of the package 100.

The sensor S1 may be, for example, manufactured as follows.

First, the circuit chip 300 is mounted on the package 100 through the adhesive members 400, and then the sensor chip 200 is mounted on the circuit chip 300 through the adhesive film 410.

Second, the package 100, the sensor chip 200, and the circuit chip 300 are connected through the bonding wire 500 by the wire bonding method.

Finally, the lid 120 is attached to seal the inside of the package 100.

In this way, the acceleration sensor S1 is manufactured.

Detection operation of the sensor S1 is described below.

The sensor S1 detects acceleration based on changes in capacitances between the movable electrodes 24 and the fixed electrodes 31, 41.

As described above, in the sensor S1, the fixed electrodes 31, 41 face the movable electrodes 24 along the direction X so that the detection gaps for detecting acceleration are provided between the side surfaces of the fixed electrodes 31, 41 and the side surfaces of the movable electrodes 24.

Here, a first detection gap DG1 is provided between the side surfaces of the movable electrodes 24 and the left fixed electrodes 31. A second detection gap DG2 is provided between the opposite surfaces of the movable electrodes 24 and the right fixed electrodes 41.

The first detection gap DG1 provides a first capacitance CS1 between the movable electrodes 24 and the left fixed electrodes 31. Likewise, the second detection gap DG2 provides a second capacitance CS2 between the movable electrodes 24 and the right fixed electrodes 41.

In the sensor chip 200, when acceleration is applied in the direction parallel to the substrate 10 and in the direction X, the whole movable portion 20 including the movable electrodes 24 is displaced together in the direction X because of the spring portion 22. The capacitances CS1, CS2 change in accordance with the displacements of the movable electrodes 24.

For example, when the movable portion 20 is displaced along the direction X in the downward direction of FIG. 2, the first detection gap DS1 is widen and the second detection gap DS2 is narrowed. In this case, the capacitance CS1 increases and the capacitance CS2 decreases so that a capacitance difference ES appears therebetween. The capacitance difference ES is determined by subtraction of the capacitance CS2 from the capacitance CS1 (i.e., ES=CS1−CS2).

Acceleration can be detected based on the capacitance difference ES.

The sensor chip 200 provides a signal reflecting the capacitance difference ES to the circuit chip 300. The signal is outputted to the external circuit through the package 100 after being processed by the circuit chip 300.

FIG. 6 is a circuit diagram of a detection circuit 350 in the circuit chip 300.

The detection circuit 350 includes a switched capacitor (SC) circuit 351 that has a capacitor 352 having a capacitance Cf, a switch 353, and a differential amplifier circuit 354. The SC circuit 351 converts the capacitance difference ES inputted from the sensor chip 200 to voltage.

In the sensor S1, a first carrier wave W1 and a second carrier wave W2 are inputted from the pad 30a and the pad 40a, respectively. The carrier waves W1, W2 have the same amplitude Vcc and are 180 degree out of phase with each other.

The switch 353 is turned on and off at a predetermined time so that the detection circuit 350 outputs a voltage V0 corresponding to the acceleration applied in the direction X. The voltage V0 is represented by the following equation:

$$V 0 = \frac{( CS 1 - CS 2 ) \cdot Vcc}{Cf}$$

In this way, the sensor S1 detects acceleration.

In the conventional sensor, the adhesive members 400 are equally disposed in the directions X, Y, as shown in FIG. 8.

Therefore, when thermal stress is applied to the sensor chip 200, the substrate 10 may have the first warpage WX that is almost equal to the second warpage WY.

The first warpage WX causes the output value of the sensor chip 200 to have temperature characteristics. Thus, the output value of the sensor chip 200 greatly varies with temperature, as shown in FIG. 9.

In contrast, in the sensor S1, the adhesive members 400 are disposed in such a manner that the substrate 10 has the first warpage WX smaller than the second warpage WY when thermal stress is applied to the sensor chip 200. Specifically, the adhesive members 400 have a layout such that the disposed area of the adhesive members 400 is larger in the direction Y than in the direction X. Thus, the first warpage WX is more reduced than the second warpage WY.

The reduction in the first warpage WX prevents the detection gaps DS1, DS2 from changing with temperature so that the output value of the sensor chip 200 is prevented from varying with temperature.

In the sensor S1, the second warpage WY may tend to occur. However, even if the second warpage WY occurs, the detection gaps DS1, DS2 vary little. Therefore, the second warpage WY has little influence on the output value of the sensor chip 200.

In FIG. 5, two circular adhesive members 400 are disposed in a line in the direction Y. The adhesive members 400 may be variable in number, shape, and size. For example, the adhesive members 400 may have a shape of an ellipse having a major axis in the direction Y, or a shape of a rectangular having long sides in the direction Y.

In such an approach, the adhesive members 400 can have the layout such that the length of disposed area in the direction Y is longer than that in the direction X, even if single adhesive member 400 is disposed.

When the adhesive members 400 have such a layout, the substrate 10 of the sensor chip 200 may be bonded to the package 100 through the adhesive members 400 at end portions of the substrate 10 in the direction Y In contrast, the substrate 10 of the sensor chip 200 may be released from the package 100 at end portions of the substrate 10 in the direction X, because no adhesive member 400 may be disposed there.

Thus, thermal stress of the package 100 may be hardly applied to the end portions of the substrate 10 in the direction X so that the substrate 10 may be prevented from being warped in the direction X.

The present inventor has examined temperature characteristics of the sensor S1, in which the adhesive members 400 are disposed as shown in FIG. 5.

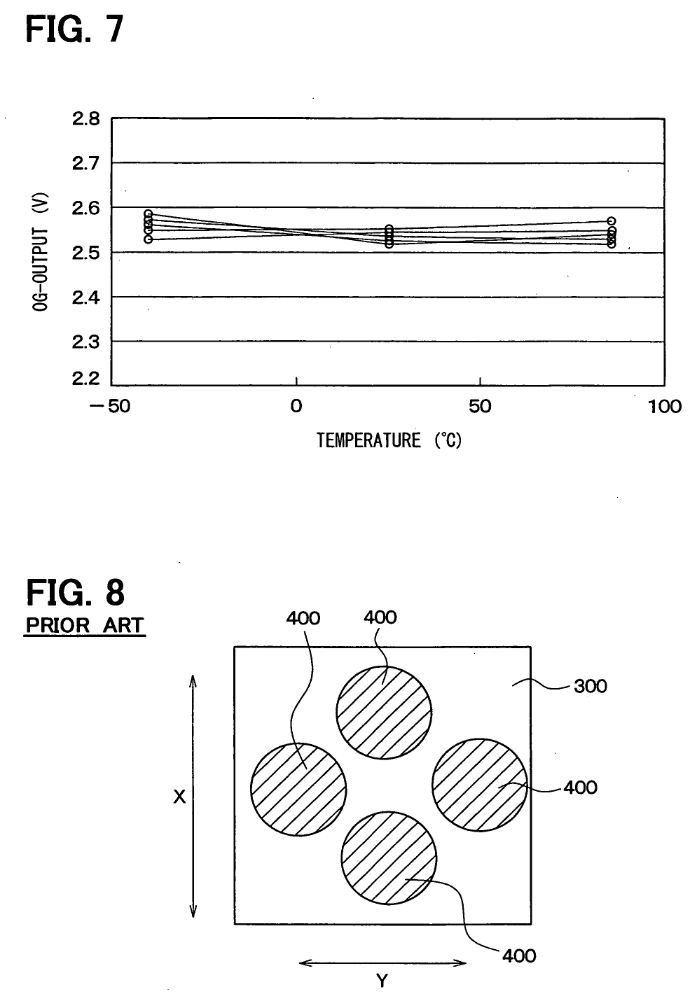

FIG. 7 shows a result of the temperature characteristics examination of the sensor S1. The horizontal axis represents temperature (° C.) and the vertical axis represents 0G-OUTPUT (V). The 0G-OUTPUT is an output produced by the sensor S1 at the time when no acceleration is applied to the sensor S1 in the direction X. If the 0G-OUTPUT varies with temperature, it can be considered that the output value of the sensor S1 has temperature characteristics

As understood from FIG. 7 and FIG. 9, in the sensor S1, variation of the output value caused by temperature variation is greatly reduced compared to the conventional sensor.

Further, the present inventor has checked the sensor chips 200 used in the temperature characteristics examination. As a result of the check, it has been shown that the warpage WX hardly occurred in the sensor chip 200.

In the sensor S1, the sensor chip 200 is supported on the package 100 through the circuit chip 300, and the adhesive members 400 are interposed between the circuit chip 300 and the package 100. The sensor chip 200 and the sensor chip 300 are fully bonded together through the adhesive film 410. Thus, bonded condition between the sensor chip 200 and the package 100 almost depends on the layout of the adhesive members 400 interposed between the package 100 and the circuit chip 300.

Therefore, alternatively, the sensor chip 200 and the circuit chip 300 may be bonded together through the adhesive member 400 having the layout shown in FIG. 5, and the circuit chip 300 and the package 100 may be fully bonded together through the adhesive film 410. Also in this case, the warpage WX in the direction X may be greatly reduced.

In the sensor S1, the movable electrodes 24 are arranged along the direction X to form the shape of comb teeth. The fixed electrodes 31, 41 are disposed in the shape of comb teeth and arranged to be engaged with the movable electrodes 24 with the detection gap.

The above embodiment may be modified in various ways. For example, the sensor chip 200 may be bonded to the package 100 through the adhesive member 400 without the circuit chip 300.

Layout of the adhesive members 400 may not be limited to the layout shown in FIG. 5, as long as the substrate 10 is prevented from being warped in the direction X, in which the sensor S1 detects acceleration applied thereto.

The electrodes 24, 31, 41 may not be limited to the comb-shaped type of electrode.

The substrate 10 may not be limited to the SOI type of substrate.

The package 100 may not be limited to the ceramic multilayered type.

Such changes and modifications are to be understood as being within the scope of the present invention as defined by the appended claims.

What is claimed is:

1. An acceleration sensor, comprising:
a sensor chip including a substrate, a movable electrode supported with respect to the substrate to be displaceable in a first direction in which acceleration is applied, and a fixed electrode facing the movable electrode with a detection gap;
a package for supporting the sensor chip; and
an adhesive member for fixing the sensor chip to the package, the adhesive member being disposed between the sensor chip and the package, wherein
the sensor detects the acceleration based on the detection gap that changes in accordance with a displacement of the movable electrode,
the substrate of the sensor chip has a first warpage in the first direction and a second warpage in a second direction perpendicular to the first direction, when thermal stress is applied to the sensor chip, and
the adhesive member is disposed in such a manner that the first warpage is smaller than the second warpage.

2. The sensor according to claim 1, wherein
the adhesive member is disposed in such a manner that a total length of a disposed area of the adhesive member in the second direction is larger than that in the first direction.

3. The sensor according to claim 1, further comprising:
a circuit chip disposed between the package and the sensor chip, wherein
the adhesive member is disposed between the package and the circuit chip.

4. The sensor according to claim 1, further comprising:
a circuit chip disposed between the package and the sensor chip, wherein
the adhesive member is disposed between the sensor chip and the circuit chip.

5. The sensor according to claim 1, wherein
the movable electrode is disposed along the first direction to have a comb shape, and
the fixed electrode has a comb shape that is engaged with the comb shape of the movable electrode with the detection gap.

6. The sensor according to claim 2, wherein
the adhesive member has a shape of an ellipse having a major axis in the second direction.

7. The sensor according to claim 2, wherein
the adhesive member has a shape of a rectangle having long sides in the second direction.

8. The sensor according to claim 2, wherein
the adhesive member has a plurality of adhesive pieces disposed in a line in the second direction.

9. The sensor according to claim 8, wherein
the adhesive pieces are circular or rectangular.

10. The sensor according to claim 2, wherein
the adhesive member is made of silicone resin, epoxy resin, acrylic resin, or polyimide resin.
